(19) United States
(12) Patent Application Publication
(10) Pub. No.: US 2013/0092683 A1
(43) Pub. Date: Apr. 18, 2013

(54) MICROWAVE OVEN ASSEMBLY AND AT LEAST A FOOD-CONTAINING RECIPIENT AND MICROWAVE OVEN PROGRAMMING METHOD

(71) Applicants: Thadeu De Avila Ribeiro Junqueira, Joinville - SC (BR); Marcelo M. Minasi, Manaus AM (BR); Maria Angelica Cocenza Ponsoni, Joinville-SC (BR)

(72) Inventors: Thadeu De Avila Ribeiro Junqueira, Joinville - SC (BR); Marcelo M. Minasi, Manaus AM (BR); Maria Angelica Cocenza Ponsoni, Joinville-SC (BR)

(73) Assignee: Whirlpool S.A., Sao Paulo SP (BR)

(21) Appl. No.: 13/520,063

(22) PCT Filed: Dec. 28, 2010
(86) PCT No.: PCT/BR2010/000432

§ 371 Date: Aug. 14, 2012

(30) Foreign Application Priority Data
Dec. 29, 2009 (BR) PI0905389-1

(51) Int. Cl. H05B 6/64

(52) U.S. Cl. CPC H05B 6/64
USPC 219/725

(57) ABSTRACT

The present invention refers to an assembly, or appliance, especially designed for better interaction between user and a microwave oven. By a single touch on the microwave oven keyboard, said assembly allows the user to program the cooking parameters of said appliance, using at least an accessory pot having a quantity scale for each type of food to be prepared.

The present invention refers to an assembly, or appliance, especially designed for better interaction between the user and a microwave oven. By a single touch of the microwave oven keyboard, said assembly allows the user to program the cooking parameters of said appliance, using at least an accessory pot having a quantity scale for each type of food to be prepared.

Additionally, the present invention refers to an interaction method and/or programming of microwave oven from the assembly now claimed.

### DESCRIPTION OF THE STATE OF THE ART

Today, electrical home appliances have countless resources. However, many of them do not yet offer possibilities or alternatives for the best use of the equipment.

As far as microwave ovens are concerned, it is known that many of them do not provide means for friendly and efficient interaction in relation to a certain recipe. Some appliances make use of specific drive buttons for certain foods and/or recipes. Furthermore, said recipes should take into account the experience of the user or end consumer with the appliance, in order to program the best means of preparing a certain dish.

In the latter case, the user must accurately provide the adjustments of the microwave oven, such as the cooking time and its functioning power in accordance with the type of food to be prepared.

In the solutions available in the state of the art, there are different technologies designed for the automatic detection of the quantity of vapor and humidity control of the cooking environment in the microwave oven cavity. Generally these technologies are linked to the development of electronic commands, which require heavy investment and an extensive schedule, these technologies being applicable to high cost products.

North American patent U.S. Pat. No. 4.459.449 refers to an appliance for cooking food, such as a microwave oven, and this appliance has a rotary device comprised of a series of menus and/or recipes. Each recipe is noted on a card fastened to said rotary device.

The methodology proposed in document U.S. Pat. No. 4,459,449, but does not use a graduated recipient capable of assisting the consumer, or end user, in accommodating various food types, such as proposed in the object of the present invention.

Brazilian case PI0003134-8 refers to a control system that summarizes in code form the information needed for programming the microwave oven to perform a specific task.

Said system is designed to facilitate handling and controlling the microwave oven by the user, yet this system does not make use of a graduated recipient capable of accommodating a large variety of foods for a series of preparation quantities, nor does it comprise a simple and efficient method designed for better control of the home appliance.

Brazilian document PI9704213 refers to an appliance and a method of controlling the cooking operation of a microwave oven which uses a system of codes. In this system, the desired cooking is carried out according to a point, or equipment operating code. The code consists of characters or numeric values that are adjusted by pushing the entry button by the user or end consumer. However, said solution does not use a graduated recipient capable of assisting the consumer in programming the microwave oven.

The North American patent U.S. Pat. No. 4,375,586 refers to a device to assist with food cooking, especially applied to microwave appliances. Said document also refers to the use of said device to assist in preparing foods, so as to provide for the input of cooking codes according to the recipe desired by the end consumer. In any case, the North American solution U.S. Pat. No. 4,375,586 does not describe the use of a graduated recipient especially designed for best user machine interaction.

Based on the above, the present invention offers an assembly and a simple and innovative method for using a microwave oven, compared to the solutions available in the state of the art today.

### OBJECTIVES OF THE INVENTION

A first objective of the present invention is to provide an assembly, or appliance, designed for microwave oven programming, capable of providing easy interaction between the user or end consumer and said appliance.

A second objective of the present invention is to provide a programming method between the user and microwave oven, capable of configuring the best cooking parameters of the appliance, in a simple and efficient manner, using a graduated accessory pot, depending on the type and desired quantity of food.

A third objective of the present invention is to achieve better performance of the equipment and lower energy consumption by way of the cooking parameters pre-programmed in the microwave appliance.

An additional objective of the present invention is to provide a method of programming and driving the microwave oven operable by a single touch of the user.

Lastly, it is an objective of the present invention that the assembly and method now proposed be of low cost for the end consumer.

### BRIEF DESCRIPTION OF THE INVENTION

The objectives of the present invention are achieved by providing a microwave oven assembly and at least a food-containing recipient, the food-containing recipient comprising at least a quantity or volume graduated scale, the type and quantity of food stored in the food-containing recipient defining a scale value, the scale value being directly associated to a drive button of the microwave oven, the drive button being associated to at least a set of parameters for operating the microwave oven.

The objectives of the present invention are also achieved by providing a method of programming the microwave oven using the assembly now proposed, such that it comprises the following steps:

a) select a type of food to be prepared in a cooking cavity of the microwave oven;

b) place said food to be prepared into a food-containing recipient having at least a volume or quantity graduated scale;

c) identify on the food-containing recipient a scale value corresponding to the quantity and type of food stored in step b;

d) position the food-containing recipient in the cooking cavity; and

e) operate the microwave oven by a single drive button, disposed on a surface of the oven, in accordance with the scale value identified in step c.

### BRIEF DESCRIPTION OF THE DRAWINGS

The present invention will now be described in greater detail, with reference to the accompanying drawings, wherein:

FIG. 1—represents a schematic view of the assembly proposed in the present invention; and

FIG. 2—represents a second schematic view of the object of the present invention.

### DETAILED DESCRIPTION OF THE DRAWINGS

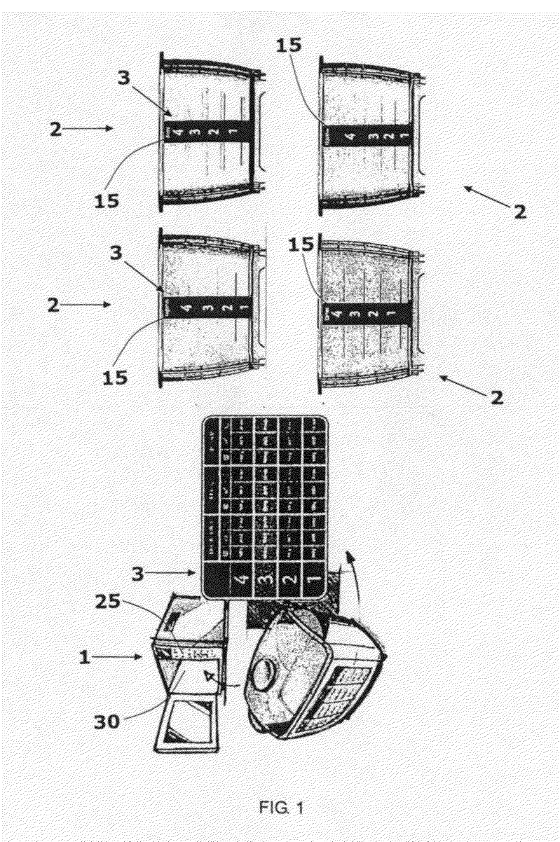

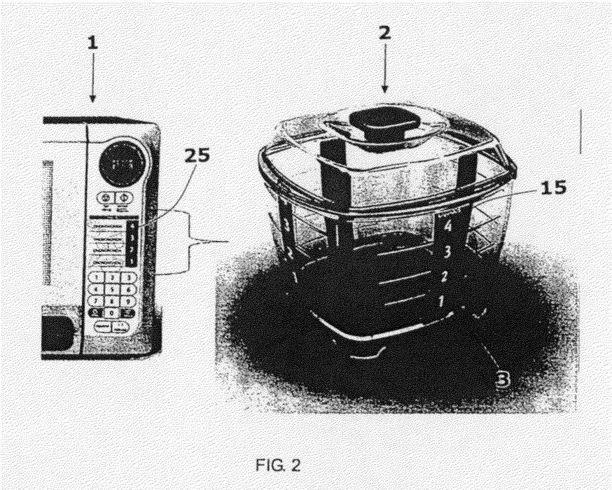

FIGS. 1 and 2 illustrate a schematic view of the microwave oven assembly 1, object of the present invention.

Said figures show that the present assembly is preferably formed by at least a food-containing recipient 2.

Said recipient 2, or accessory pot, can be made of various kinds of materials compatible with the preparation of foods in a microwave oven 1.

In a significantly innovative manner, compared to the solutions founds in the state of the art, the present recipient 2 comprises at least a quantity or volume graduated scale 3, such that the type and quantity of food stored in the food-containing recipient 2 defines a certain scale value 15.

FIGS. 1 and 2 show a preferred embodiment for the assembly now proposed. FIG. 1 illustrates in greater detail the various possibilities for configuring the graduated scale 3 for a plurality of foods. In other words, the food-containing recipient 2 comprises a plurality of quantity or volume graduated scales 3, for a plurality of food types, such as rice, vegetables, and others.

On each face, or surface of the recipient 2, there is provided a graduated scale 3.

The scale value 15, according to the teachings of the present invention, is directly associated to a drive button 25 of the microwave oven 1, said button 25 being associated to at least a set of parameters for driving the microwave oven 1. This case refers to an assembly capable of providing easy interaction of the user, or end consumer, with the microwave oven 1, as a simple touch of the drive button 25 is capable of driving said oven 1, with the pre-programmed drive parameters.

More especially, the set of parameters for driving the microwave oven 1 is associated to a cooking time value Tc and to a cooking power value Pc pre-programmed in the microwave oven 1, and these are associated to a cooking recipe for the food stored in the food-containing recipient 2.

In FIG. 1, it is also possible to note that the quantity or volume graduated scale 3 comprises one or more scale values 15, said values being associated to the respective drive buttons 25. Said buttons 25 are defined, or identified, by way of numbers, symbols, colors or a combination thereof.

In this case, the concept related to the use of the present assembly allows substantially fast interaction between user and microwave oven 1, by means of a language of symbolic values, this being altogether highly intuitive for the consumer.

This concept allows the consumer to create a direct association between the food to be prepared and the drive of the microwave oven 1, pursuant to the desired recipe. Therefore, the present assembly will assist the user to identify the type and quantity of food to be prepared, suggesting in a clear and direct manner of the drive key or button 25 of the microwave oven 1 capable of operating it at the ideal power and time.

It is important to highlight that the optimized operation of the oven 1 allows not only better cooking and/or defrosting of the product, but also better energy savings of the appliance in light of the better use of its functioning cycle.

It also to worth emphasizing that said functioning cycles are pre-programmed in the microwave oven 1 for a wide variety of foods and/or recipes.

The present invention is preferably applied to low-end products in a simple manner and with reduced cost for the end consumer, when compared to the solutions available today.

In a significantly innovative manner, the present invention refers to a microwave oven programming method 1, which uses the assembly now proposed.

It is a highly simplified and accessible technology for the end consumer.

Said method comprises the following steps:

a) select a type of food to be prepared in a cooking cavity 30 of the microwave oven 1;

b) place said food to be prepared in a food-containing recipient 2 having at least a volume or quantity graduated scale 3;

c) identify on the food-containing recipient 2, a scale value 15 corresponding to a quantity and type of food stored in step b;

d) position the food-containing recipient 2 in the cooking cavity 30; and

e) operate the microwave oven 1 by way of a single drive button 25, disposed on a surface 20 of the oven 1, according to the scale value 15 identified in step c.

For the method described above, it should be underlined that the operation of the drive button 25 is performed by a single touch, that is, in an altogether easy and direct way for the consumer, as already mentioned.

Based on the method now claimed, it is possible to operate the microwave oven 1, by way of the drive button 25, in a cooking time value, or defrost Tcd, and in a drive power value Pc pre-programmed in the microwave oven 1, according to the type and quantity of food stored in the food-containing recipient 2.

As already commented, said scale value 15, used in the present method, and its respective drive button 25, are defined by way of numbers, symbols, colors, or a combination thereof.

Lastly, it is important to point out that the present invention achieves its objectives in that an assembly and a microwave oven programming method 1 is proposed, these being used in a highly simplified and efficient manner for the best use of the appliance by the end consumer.

Additionally, said use, as already addressed, allows best use of energy consumed by the equipment, in that an optimized drive cycle is obtained by way of the drive parameters pre-programmed in the oven 1.

Having described examples of preferred embodiments, it should be understood that the scope of the present invention encompasses other possible variations, and is limited only by the content of the accompanying claims, potential equivalents being included therein.

1. An assembly of a microwave oven and a food-containing recipient, wherein:
the food-containing recipient comprises at least a quantity or volume graduated scale, the graduated scale being configured to create a direct association between a food to be prepared and a drive of the microwave oven,
a type and quantity or volume of food stored in the food-containing recipient defines a determined scale value at the graduated scale,
the scale value being directly associated to a respective drive button of the microwave oven,
the drive button being associated to at least a set of parameters for driving the microwave oven.

2. The assembly of claim 1, wherein driving the microwave oven is done by a single touch at a drive button.

3. The assembly of claim 1, wherein the food-containing recipient comprises a plurality of quantity or volume graduated scales for a plurality of food types.

4. The assembly of claim 1, wherein the set of parameters for driving the microwave oven is associated to a cooking time value and to cooking power value pre-programmed in the microwave oven.

5. The assembly of claim 1, wherein the set of parameters for driving the microwave oven is associated to a cooking recipe for the food stored in the food-containing recipient.

6. The assembly of claim 1, wherein the quantity or volume graduated scale comprises one or more scale values and respective drive buttons defined by numbers, symbols, colors or a combination thereof.

7. A microwave oven programming method comprising:
selecting a type of food to be prepared in a cooking cavity of the microwave oven;
placing said food to be prepared in a food-containing recipient having at least a volume or quantity graduated scale that creates a direct association between the food to be prepared and a drive of the microwave oven;
identifying on the food-containing recipient, a scale value corresponding to the quantity or volume and the type of food stored;
positioning the food-containing recipient in the cooking cavity; and,
driving the microwave oven by way of a single drive button, disposed on a surface of the oven, according to the respective scale value.

8. The method of claim 7, wherein the microwave oven is driven by a single touch at the drive button.

9. The method of claim 7, wherein the operation of the drive button, is capable of driving the microwave oven in a cooking time value, or defrost, and in a drive power value pre-programmed in the microwave oven, according to the type and quantity of food stored in the food-containing recipient.

10. The method of claim 7, wherein the scale value and its respective drive button are defined by numbers, symbols, colors or a combination thereof.
